(19) United States
(12) Patent Application Publication
(10) Pub. No.: US 2018/0282212 A1
(43) Pub. Date: Oct. 4, 2018

(54) METHOD OF RECYCLING OILY WASTE SO AS TO PROVIDE A MULTI-USE PAVEMENT

(71) Applicants: Francisco Andres ALFONSIN PYM, Col. Maria de la Piedad (MX); Guillermo CHAVERO LOPEZ, Col. Maria de la Piedad (MX)

(72) Inventors: Francisco Andres ALFONSIN PYM, Col. Maria de la Piedad (MX); Guillermo CHAVERO LOPEZ, Col. Maria de la Piedad (MX)

(21) Appl. No.: 16/002,566

(22) Filed: Jun. 7, 2018

Related U.S. Application Data
(63) Continuation-in-part of application No. 12/993,507, filed on Dec. 21, 2010, now abandoned.

(30) Foreign Application Priority Data
May 21, 2008 (MX) MX/A/2008/006540

(51) Int. Cl. C04B 18/18; C04B 26/26; C08L 95/00; E01C 7/08; E01C 19/02

(52) U.S. Cl. CPC C04B 18/18; C04B 26/26; C04B 2111/0075; E01C 7/085; E01C 19/02; C08L 95/00

(57) ABSTRACT

A method of forming a multi-use dry pavement from oily waste derived from hydrocarbons has the steps of combining the oily waste with calcium oxide so at as to suspend and homogenize the wastes, adding hydrogen peroxide and water to the oily mixture, and adding ammonium sulfate and water to the mixture. The hydrogen peroxide is mixed with equal amounts of water. The ammonium sulfate is mixed with an equal amount of water. The homogenization process continues until the mixed material forms a granulate. The granulate can be compacted and then used as a pavement.

### CROSS-REFERENCE TO RELATED APPLICATIONS

The present application is a continuation-in-part of U.S. patent application Ser. No. 12/993,507, filed on Dec. 21, 2010, and entitled “Method for Recycling Oily Waste in Order to Produce a Multi-Use Dry-Type Modified Pavement”, presently pending.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to the recycling of oily wastes. More particularly, the present invention relates to the use of oily waste and the modification of such oily wastes in order to produce a multi-use pavement.

### 2. Description of Related Art Including Information Disclosed Under 37 CFR 1.97 and 37 CFR 1.98

Currently, huge amounts of oily wastes are being created. These are created during the process of hydrocarbon exploitation. They are also related to the manufacturing and derivation of such hydrocarbons through the production of smudges, sludge, emulsions, ground deposits, oils and waste oils. Conventional control and handling methods for these wastes are generally based upon the physical/chemical makeup of the compounds. Conventional control and handling methods can include disintegration through thermal destruction and confinement. The disintegration through thermal destruction can create carbon and undesirable carbon gas. The confinement merely transfers the pollution or contamination from one location to another.

Generally, these wastes are not considered to be useful for other productive purposes. They have not been used as raw materials for other processes. These are not used because these pollutants can leach particles when being improperly exposed to the environment. In other words, they can be transferred to water bodies or so as to produce water contamination or ground contamination.

The handling of these oily wastes, along with the high cost for confinement and transportation, has only resulted in a loss to the producer of such oily wastes. These oily waste materials are not being taken advantage of It is known that in Switzerland, a portion of such oily waste can be incorporated in manufacturing asphalts and pavements. The oily wastes are proportioned according to a combustible liquid phase on the sediments or incorporated into asphalt aggregates in order to dissipate the solid wastes in an environmentally-safe manner and to reduce the negative impacts to the environment. Another technique for treating the oily waste is to thicken the waste, makes the waste with raw soil and hydrated calcium oxide (i.e. lime) so as to form a type of black asphalt. This is a very undesirable manner of using such oily wastes since it is very difficult to apply. The resulting mix used on road surfaces can result to the contamination by migration to the surrounding areas. Such oily waste treatment provides minimal plasticity.

Soil mechanics engineering for the traditional creation of pavements requires a natural bank. Aggregates have been used in such natural banks. They can be used for asphalt or hydraulic concretes, terrace bodies, road bases and sub-bases. The materials from natural banks are selected in a manner so as to support traffic loads without being deformed.

It is an object of the present invention to provide a method that facilitates the ability to use oily wastes in a usable pavement product.

It is another object of the present invention to provide a process for treating oily wastes which reduces the negative impacts to the environment.

It is another object of the present invention which minimizes the risks to the environment during the handling of the oily wastes.

It is still a further object the present invention to provide a process for treating oily wastes which provides a dry-type modified pavement with superior properties.

These and other objects and advantages of the present invention will become apparent from a reading of the attached specification and appended claims.

### BRIEF SUMMARY OF THE INVENTION

The present invention is a multi-use type modified pavement which is based upon oily waste derived from petroleum or hydrocarbons. This modified pavement adds a concentration of 20 to 30% by weight of calcium oxide to the oily waste. This serves to homogenize and suspend the waste until forming a material with a ¼ fine granulometry . Each cubic meter of the oily material is added to a mixture of between 1 to 12 liters of hydrogen peroxide with water in a ratio of 50% to 50%. A mixture of between 1 to 12 liters of degreaser based upon ammonium sulfate with water is added. The ratio of the ammonium sulfate and water is equal.

The present invention is also a process for obtaining a multi-use modified pavement by recycling oily waste. This process includes the steps of: (1) selecting a material from which the oily wastes are derived; (2) determining the amount of corrosiveness, reactivity, explosiveness, flammability, and toxicities of the only waste; (3) analyzing the concentration of hydrocarbons; and (4) homogenizing the wastes by adding 1 to 12 liters of equal amounts of hydrogen peroxide and water and adding 1 to 12 liters of equal amounts of ammonium sulfate and water to each cubic meter of the oily material. The step of homogenizing can include the steps of mixing manually or mechanically. The wastes are homogenized according to their volume and density.

The method of the present invention further includes adding calcium oxide and water in a ratio of one-to-one ratio with the concentration of the total hydrocarbon components in the oily material.

In the method of the present invention, the step of homogenizing is for a period of time of approximately 45 minutes. A vapor extractor is cooperative with the homogenization so that vapors can be collected and extracted. The vapors are condensed through a Venturi system and then collected in cooling tanks. The recovered condensate during the chemical process is filtered with activated carbon. The recovered and filtered liquid phase is reincorporated into the initial stage of the process for the homogenization of the oily wastes. During the step of homogenization, the oily waste will be converted into a granulate that has the appearance of clay with a ¼ fine granulometry.

In the method of the present invention, the product of the step of homogenizing is compacted and then used in pavement.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### DETAILED DESCRIPTION OF THE INVENTION

The oily wastes are homogenized according to the volume and density thereof. The step of homogenization can be carried out manually or mechanically. Shovels, diggers or mechanical systems can be used for the mechanical homogenization. As the oily waste are homogenized, hydrogen peroxide and a surfactant are added to each cubic meter of the oily wastes. In particular, a mixture of 1 to 12 liters of equal amounts of hydrogen peroxide and water are added. Simultaneously, a mixture of 1 to 12 liters of equal amounts of ammonium sulfate and water are added. The ammonium sulfate and water will act as a fluidizer.

Once a homogenous consistency is achieved, and until obtaining the optimized and fluidized density, the mixture is broken up so as to observe the texture and viscosity change. At a certain point in time, the mixture is homogenized constantly in a one-to-one ratio with the total hydrogen parts. For example, if the sludge volume is one cubic meter having a total hydrocarbon parts concentration from 20 to 30%, the calcium oxide should be used in an amount of between 20 and 30% by weight. When humidity is low, a lower ratio is used. In contrast, higher humidities will require a higher ratio to be used.

The chemical reaction process lasts approximately 45 minutes relative to the volume to be treated. In order to prevent any sort of contamination or pollution to the atmosphere, the vapors are extracted with a bell-type dome or other type of extractors. The vapors that are collected are condensed to a Venturi system so as to be collected by cooling tanks. The condensate that is recovered during the chemical reaction process are filtered with activated carbon. The recovered and filtered liquid phase is reincorporated into the initial stage of the process so as to mix and homogenize the wastes.

In the process of the present invention, the homogenization will continue so as to experience absorbing exothermically reaction and evaporation of the humidity of the mass. This creates a transformation of the treated oily waste into granules of organoleptic presence with a clay appearance having a granularity of ¼ fines granulometry. The particles will be non-greasy to the touch.

The granules are then cooled. At this stage, they do not show any traces of the oily wastes. If these materials are mixed with water, the water would not show any oily traces and the water would be transparent or crystal clear. Only the suspension finds would be observable in the water.

When used as a pavement, the material should have a compactability that is not less than 90% in the proctor or asstho test ranges. The actual humidity should be less than 20%. The optimal humidity for application would actually be between 6 and 8.8% maximum. This is the optimum compacting level so as to ensure the compacting, cementing and adherence quality for the pavements.

The physical-chemical properties of the present pavement, by virtue of its permeability to water, will prevent sludge formation when being consolidated uniformly in road bases or sub-base construction. The physical and mechanical properties work as an isolating agent and distribute loads uniformly. As such, this avoids failure due to humidity of the asphalt.

The material produced by the process of the present invention has certain physical-chemical specifications and characteristics. The color is a sand-type beige varying from suigenerius clear to a dark tone. The odor will have a light odor of hydrocarbons. The material is non-toxic. The pH is between six and nine. The chemical composition would be water-insoluble carbonate. The granulometry is ¼ TO fines. The compacting degree is a minimum of 90%. The material is 100% permeable to water. The material is 100% in soluble in water. The maximum humidity degree is 8.8%. The material will cement in cold temperatures. The resistance to axial compression is between 10 and 24 kg/cm². The minimum loose specific weight is 950 kg/cm³. The maximum compacted weight of the material is 1825 ka/cm³. There is no variation of physical and mechanical properties when exposed to environmental or outdoor conditions. The material can be disaggregated and re-reused in other places without suffering any changes in the mechanical or material properties of the composition.

The present invention has a variety of applications. In particular, the material produced by the present method can be used for cold patching, terrace body conforming, road bases and sub-bases to improve asphalt or hydraulic concrete uniformity, cores for dam containment, for bridge ramps at approaches, for containment, for the sealing of dirt roads in the lining of dirt roads, in crossings such as shallow places where rivers cross secondary roads, as absorption joints and expansion joints between pavement sections, as secondary road linings, and as an addition with other solid aggregates and commercial asphalt substances so as to enhance the resistance of such materials.

The multi-use dry-type modified pavement of the present invention is quite different than traditional asphalt pavements. The pavement of the present invention is obtained through oily waste recycling and by accelerated chemical oxidation without the use of any aggregates or bank materials. The pavement of the present invention has physical and mechanical properties of water in solubility and water permeability, of high compactability and cementability. The pavement has the qualities of adherence and cohesiveness with a minimal amount of plasticity. As such, this enables the instantaneous use in areas having compression or axial loads. The present invention allows cold application without any additives. The material used for the pavement of the present invention can be applied in a minimal amount of time in comparison with conventional pavement materials.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. A method of forming a pavement from an oily waste that is derived from hydrocarbons, the method comprising the steps of:
adding calcium oxide in an amount of 20 to 30 weight % to the oily wastes so as to homogenize the oily waste until forming a material with one quarter fines granulometry;
adding equal amounts of hydrogen peroxide and water to the oily mixture, 1 to 12 liters of the mixture of hydrogen peroxide and water is added to each cubic meter of the oily mixture; and
adding a mixture of equal amounts of ammonium sulfate and water to the oily a mixture, 1 to 12 liters of the ammonium sulfate and water mixture are added to each cubic meter of the oily mixture; and
allowing a chemical reaction of the oily waste, the calcium oxide, the hydrogen peroxide in the ammonium sulfate to occur.

2. The method of claim 1, further comprising the steps of:
selecting a material from which the oily wastes are derived;
determining and analyzing corrosiveness, reactivity, explosiveness, flammability and toxicity of the oily waste; and
analyzing a concentration of total present hydrocarbons in the oily wastes.

3. The method of claim 1, the step of homogenizing being carried out manually.

4. The method of claim 1, the step of homogenizing being carried out mechanically.

5. The method of claim 1, the step of homogenizing carried being carried out for approximately 45 minutes.

6. The method of claim 1, further comprising:
collecting vapors from the step of homogenizing;
condensing the collected vapors;
collecting the condensed vapors; and
filtering the recovered condensate.

7. The method of claim 6, the step of collecting the vapors being in a bell-shaped dome.

8. The method of claim 7, the step of condensing the vapors being through a Venturi system.

9. The method of claim 8, the step of filtering being by passing the recovered condensate through activated carbon.

10. The method of claim 9, wherein the filtered liquid phase of the recovered condensate is introduced into the step of homogenizing.

11. The method of claim 1, further comprising:
continued homogenizing until the oily mixture forms a granulate.

12. The method of the claim 11, the granulate having a one quarter fines granularity.

13. The method of claim 1, further comprising:
compacting the mixture resulting from the homogenization process.

14. The method of claim 14, further comprising:
forming a pavement with the compacted mixture.
